(19) United States
(12) Patent Application Publication
(10) Pub. No.: US 2006/0084332 A1
(43) Pub. Date: Apr. 20, 2006

(54) Heat shield

(75) Inventors: Sebastian Muschelknautz, Muenchen (DE); Heinz Posselt, Muenchen (DE); Franz Leher, Winzer (DE); Georg Lehner, Bernried (DE); Michael Nagel, Lubmin (DE); Felix Schauer, Greifswald (DE)

Correspondence Address: CROWELL & MORING LLP;INTELLECTUAL PROPERTY GROUP, P.O. BOX 14300, WASHINGTON, DC, 20044-4300, US

(73) Assignees: Linde Aktiengesellschaft, Wiesbaden (DE); MAN DWE GmbH, Deggendorf (DE); Max-Planck-Gesellschaft zur Foerderung der Wissenschaften e.V., Muenchen (DE)

(21) Appl. No.: 11/124,137

(22) Filed: May 9, 2005

(30) Foreign Application Priority Data
May 10, 2004 (DE) 10 2004 022 934.1

(51) Int. Cl. D03D 15/00; B32B 15/14

(52) U.S. Cl. 442/6; 442/228; 442/232; 442/233; 442/234; 442/235

(57) ABSTRACT

A heat shield having a thermally conductive body. The material of the body is composed of a fibre composite material, preferably carbon fibre, glass fibre, glass-fibre-reinforced plastic and/or aramide, and layers of a heat-conductive metal. Cooling tubes may be applied to an outer surface of the body, incorporated into an outer fibre layer of the body, and/or formed directly within the outer fibre layer.

This application claims the priority of German Application No. 10 2004 022 934.1, filed May 10, 2004, the disclosure of which is expressly incorporated by reference herein.

### BACKGROUND AND SUMMARY OF THE INVENTION

The invention relates to a heat shield having a thermally conductive body.

Experiments are being carried out on a hydrogen plasma at a temperature of several million degrees in the course of physical fusion research. The plasma is fired into an essentially annular area by means of a magnetic field. The magnetic field is produced by a special arrangement of planar and non-planar superconductive solenoid coils, which are cooled to temperatures around 4 Kelvin by cryogenic helium.

Heat shields, inter alia, are also used for thermal insulation between the hot plasma and the cryogenic superconducting system. The heat shield has a thermally conductive body which, for example, is cooled by liquid nitrogen or by cold helium gas, in order to minimize the heat transferred by thermal radiation.

The thermally conductive body of the heat shield has until now frequently been produced from copper. Owing to its high thermal conductivity, copper has the advantage that the entire shield can be quickly and uniformly cooled to the desired temperature.

However, copper is not very suitable for isolation of powerful superconductive solenoid coils since the solenoid coils induce eddy currents in the copper, which cause severe forces acting on the heat shield. Thus, for applications such as these, stainless steel has until now been used, rather than copper, as the material for the body of the heat shield.

In the plasma-physical experiments mentioned above, the plasma is enclosed in a wound area in the form of a flexible tube, around which the superconductive magnet system must be arranged as closely as possible in order to make it possible to produce the strong required magnetic fields in the plasma area. The heat shield that is used for insulation must therefore be matched to the contours of the plasma area. However, it is difficult to shape stainless steel to such necessary contours, and a copper shield cannot be used, or can be used only with limitations, owing to the strong magnetic fields.

The object of the present invention is thus to develop a heat shield which has high thermal conductivity, can also be matched to complex shapes, and in which the formation of eddy currents is as far as possible suppressed.

This object is achieved by a heat shield having a thermally conductive body, in which the material of which the body is composed comprises a fibre composite material, preferably carbon fibre, glass fibre, glassfibre reinforced plastic and/or aramide, and a metal.

The body of the heat shield according to the invention is manufactured from a fibre composite material. Carbon and glass fibre meshes as well as glass-fibrereinforced plastics or aramide may, in particular, be used as fibre composite materials. Fibre composite materials of this type, which are also known, for example, from automobile or aircraft construction, can be processed particularly well, and shaped in widely different ways very well. To this extent, there are virtually no restrictions on the shaping of the heat shield. The fibre composite materials furthermore have the advantage that extremely robust heat shields can be formed with a comparative low weight.

The heat shield may be in the form of an integral item or else may have two or more individual bodies. Particularly in the case of complex shaping of the heat shield, as is the case by way of example for a heat shield of the plasma or fusion experiments mentioned initially, the shield is formed from two or more individual bodies, which are each designed in the manner according to the invention. The size of the individual bodies is typically more than 200×200 mm². The body or bodies may, however, also have a size of several square metres, with simple shaping.

The high body thermal conductivity which is a major factor for the heat shield is achieved by incorporating elements composed of metal, which have high thermal conductivity, in the body. Copper is preferably used, owing to its high thermal conductivity. Depending on the arrangement, the number and the sizes of the metal elements, the thermal conductivity of the heat shield can be influenced and set as required.

The metal elements may essentially have any desired shape and, for example, may be in the form of rectangles or squares. However, metal elements in the form of rods, threads, strips or networks are preferably incorporated in the body. If the heat shield is used for thermal insulation of superconductive magnets, then the formation of eddy currents in the metal elements is effectively suppressed by an elongated configuration of the metal elements. In the case of a metal element in the form of a strip, for example, it is thus possible to form only small, closed current loops extending over the width of the metal strip to a maximum extent. The induced forces remain correspondingly low.

Suitable arrangement of the, in particular, elongated metal elements allows high thermal conductivity to be achieved over the entire body. If the metal strips, metal threads or metal rods are arranged sufficiently close to one another, preferably parallel to one another, then adequate thermal conductivity can also be achieved transversely with respect to the metal elements. The electrical conductivity in the transverse direction remains virtually zero, however, nevertheless, particularly when using glass fibre materials, thus preventing eddy currents.

It has been found that metal elements with a thickness of between 0.1 and 3 mm, preferably of between 0.1 and 1 mm, are particularly advantageous. The area extent of a metal element is preferably more than 200×200 mm², although, depending on the application, the metal element may also extend over the entire body of the heat shield. Metal elements with these dimensions allow the thermal conductivity of the heat shield to be set in accordance with the requirements. On the other hand, the metal elements are thin enough that they can be permanently incorporated in the fibre composite material.

By way of example, the body of the heat shield can be manufactured from glass fibre mesh which is impregnated with a compound similar to resin. The metal elements, for example metal threads or a metal network, are placed on the glass fibre mesh. If the metal elements have sizes corresponding to those stated above, then the resin on or in the glass fibre mesh flows around the individual metal elements and binds them into the overall structure in a robust form. When using a metal element similar to a network, a particularly robust joint is achieved since the resin impregnates through the metal network.

The body of the heat shield preferably has two or more layers of the fibre composite material and of the metal. Thus, for example, two or more layers of fibre mesh are placed one on top of the other in accordance with the desired shape, and are shaped, in accordance with the desired shape. The metal elements are introduced between the individual mesh layers. The metal elements are fixed in the body by connecting the mesh layers to one another. The number and strength of the individual layers of glass fibre mesh depends in particular on the required heat shield robustness. Generally, an overall thickness of less than 20 mm, and particularly preferably of less than 10 mm, will be sufficient. Heat shields which are subject to particularly severe loads may, however, also have a thickness of several centimetres.

Preimpregnated fibre composite materials, so-called prepregs, have proved particularly advantageous. These fibre composite materials are already impregnated with a resin or a compound similar to resin. The fibre composite material is generally cured in an autoclave subject to the influence of pressure, temperature and vacuum. During this process, the fibre parts (which are initially placed loosely one on top of the other) and the metal elements placed between them are compacted. The resin is distributed uniformly over the entire body, and cures with crosslinking. A uniform robust structure is formed, in which the metal elements are firmly embedded.

The body is preferably formed symmetrically from different layers. In this case, the layers of fibre composite material and metal elements are arranged symmetrically with respect to the centre plane of the body in a direction at right angles to the body surface. By virtue of the materials, the individual layers have different thermal coefficients of expansion. The symmetrical arrangement avoids any effect similar to a bimetallic strip as the heat shield cools down. The layer contraction that results during cooling down takes place symmetrically with respect to the centre plane, so that the body contracts uniformly, without bending.

The heat shield is used to reduce heat transferred by thermal radiation. The heat radiated from a body is proportional, inter alia, to the emissivity of the body surface, with the emissivity of metals being considerably less than that of plastics or fibre composite materials. At least one outer surface of the body of the heat shield is therefore advantageously composed of a metal. This can be achieved by at least some of the metal elements being applied directly to the outer surface of the body that is manufactured from the fibre composite material.

However, it has been found to be better to provide the metal elements in the interior of the body of the heat shield, since this makes it possible to produce a firmer connection between the metal elements and the rest of the body, in particular the fibre composite material. In this case, a metal, for example aluminium, is vapour deposited onto the surface of the body, which is composed of fibre composite material, or a metal foil is adhesively bonded onto it, in order to reduce the emissivity.

Cooling tubes are preferably provided in order to cool the heat shield and are mounted on one surface of the body, preferably being adhesively bonded or soldered to it. The cooling tubes may also be directly laminated into the uppermost layer of fibre composite material, that is to say the cooling tubes are covered by a layer of fibre composite material. Furthermore, it has also been found to be advantageous to form lines which are suitable for carrying the cooling medium from the fibre composite material itself.

The cooling tubes or lines for the cooling medium are preferably firmly attached to the body at only one end, and are otherwise connected to the body via flexible, thermally conductive intermediate pieces, for example flexible copper braids. Furthermore, it may also be advantageous for the cooling tubes to be composed of two or more subelements which make thermally conductive contact with one another. This avoids thermal stresses which can result from the cooling tubes and the body having different cooling rates.

The heat shield according to the invention can be used particularly advantageously for insulation of superconductive magnets, since the choice and arrangement of the metal elements makes it possible to considerably reduce, or even entirely prevent the formation of eddy currents in the heat shield. In this case, in particular, it has been found to be advantageous to use individual elongated metal elements which are insulated from one another, for example insulated wires or wires arranged at a distance from one another, or, in a very particularly preferred manner, a network produced from insulated metal wires. The thermal conductivity in the body of the heat shield can be set specifically by suitable choice of the size, number and arrangement of the metal elements. The use of fibre composite materials allows the production of heat shields of virtually any desired shape. Furthermore, the embodiment according to the invention allows weight to be saved, in comparison to a heat shield composed of metal.

The heat shield according to the invention can also advantageously be used for the thermal insulation of a tank in a hydrogen-powered vehicle. In this case, on the one hand, the low weight of the heat shield has a positive effect. Furthermore, in vehicle design, it is frequently necessary to use tank shapes which are very specifically matched to the spatial conditions in the vehicle. The thermal insulation should then, of course, likewise be designed to save space. The capability of fibre materials to be shaped well results in major advantages here.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a section through a part of a heat shield in accordance with an embodiment of the present invention.

FIG. 2 shows a section along the line A-A in FIG. 1, and

FIG. 3 shows an alternative embodiment of the body of a heat shield in accordance with an embodiment of the present invention.

### DETAILED DESCRIPTION

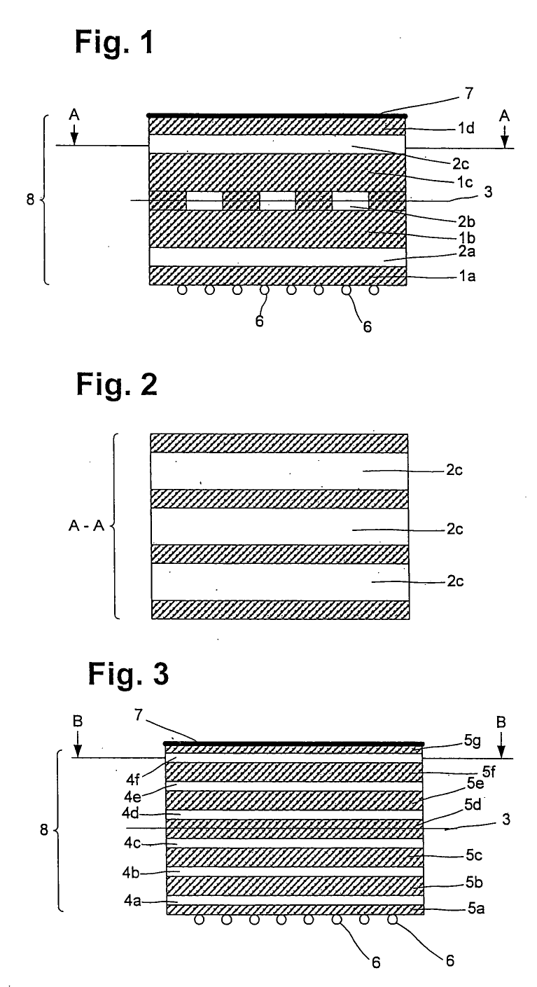

FIG. 1 shows a section through a part of a heat shield in accordance with an embodiment of the present invention. The illustrated part represents a detail from the entire heat shield. The body 8 of the heat shield is produced from two or more layers 1a, 1b, 1c, 1d of a glass fibre mesh. Narrow strips 2a, 2b, 2c of a copper sheet are placed between the layers 1a, 1b, 1c, 1d. The strips 2a and 2c run essentially parallel to one another while, in contrast, the central copper strips 2b are arranged at right angles to the sheet-metal strips 2a, 2c and at right angles to the plane of the drawing. Two or more of the copper strips are arranged parallel to one another on a plane at right angles to the plane of the drawing. This is shown by the example of the plane A-A in FIG. 2. The entire arrangement is constructed symmetrically with respect to the plane 3 which runs at right angles to the plane of the drawing.

Instead of the metal strips 2a, 2b, 2c illustrated in FIG. 1, it is also advantageous to use metal networks 4a, 4b, 4c, 4d, 4e, 4f for thermal conduction in the heat shield. FIG. 3 illustrates a heat shield constructed in this way. Networks 4a, 4b, 4c, 4d, 4e, 4f of copper wire are inserted into the body of the heat shield, alternating with carbon fibre layers 5a, 5b, 5c, 5d, 5e, 5f, 5g. The individual layers 4a, 4b, 4c, 4d, 4e, 4f, 5a, 5b, 5c, 5d, 5e, 5f, 5g are once again formed symmetrically with respect to the centre plane 3. The carbon fibre layers 5a, 5b, 5c, 5d, 5e, 5f, 5g are preferably preimpregnated and are connected to one another in a known manner under the influence of pressure and temperature. However, it is also possible to connect the individual layers 5a, 5b, 5c, 5d, 5e, 5f, 5g to one another by manual lamination.

In any case, the resin also flows through the meshes of the copper networks 4a, 4b, 4c, 4d, 4e, 4f which are positioned between the carbon fibre layers 5a, 5b, 5c, 5d, 5e, 5f, 5g, so that they are firmly anchored in the interior of the heat shield by the crosslinked resin once it has cured.

The copper networks 4a, 4b, 4c, 4d, 4e, 4f are preferably woven from insulated wire, so that the electric current within the network 4a, 4b, 4c, 4d, 4e, 4f can in each case flow only along one copper wire in the network 4a, 4b, 4c, 4d, 4e, 4f. It is therefore impossible for eddy currents to occur within a network 4a, 4b, 4c, 4d, 4e, 4f. When using networks such as these composed of insulated wires, one layer 4a, 4b, 4c, 4d, 4e, 4f may in each case be formed from a simple network. In contrast to the arrangement of the copper strips 2c in the form of strips as shown in FIG. 2, a network 4f extends over the entire cross section of the body 8 in this case, on a plane at right angles to the plane of the drawing, for example on the plane B-B.

It has been found that metal networks such as these can also be produced from uninsulated wires. However, in this case, it is expedient (in an analogous manner to the embodiment shown in FIG. 2) to arrange two or more metal networks in the form of strips alongside one another and separated from one another on a plane 4a, 4b, 4c, 4d, 4e, 4f, in order to keep the formation of eddy currents low. The strips of two adjacent layers of metal networks, for example the planes 4c and 4d, are then preferably each aligned at right angles to one another in order to distribute the heat as uniformly as possible within the heat shield.

The thermal conductivity of the heat shield can be set in a defined manner by the number of metal elements introduced into the body 8 of the heat shield, that is to say the copper networks 4a, 4b, 4c, 4d, 4e, 4f in FIG. 3.

Cooling tubes 6 are adhesively bonded to the fibre material layer 1a or 5a on one side of the body 8. The cooling tubes run in a meandering shape on the surface and are fed with liquid nitrogen or gaseous helium as a coolant. The first layer 2a or 4a of metal elements starting from the cooling tubes 6 is located as close as possible to the surface of the body 8, in order to achieve good heat transfer from the cooling tubes 6 to the metal layer 2a, 4a. The metal layer, that is to say the metal strip 2a or the copper network 4a, is covered only by a thin fibre mesh layer 1a, 5a, which is used for robust attachment of the metal layer 2a, 4a.

An aluminium foil 7 is adhesively bonded onto the outermost fibre mesh layer 1d or 5g on the opposite side of the heat shield. The aluminium foil 7 has a considerably lower emissibility than the fibre material, thus making it possible to significantly reduce the thermal radiation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Heat shield having a thermally conductive body wherein the material of which the body comprises a fibre composite material including at least one of carbon fibre, glass fibre, glass-fibre reinforced plastic and aramide, and a metal.

2. Heat shield according to claim 1, wherein the body contains metal elements in the form of at least one of rods, threads, strips networks.

3. Heat shield according to claim 2, wherein the metal elements have a thickness of between 0.1 mm and 3 mm.

4. Heat shield according to claim 2, wherein the metal elements have a thickness of between 0.1 mm and 1 mm.

5. Heat shield according to claim 3, wherein the body has a plurality of fibre composite layers and a plurality of 5 metal layers.

6. Heat shield according to claim 5, wherein the layers are arranged symmetrically with respect to a centre plane of the body in a direction at right angles to at least one body outer surface.

7. Heat shield according to claim 6, wherein the at least one outer surface of the body is composed of a metal.

8. Heat shield according to claim 7, wherein cooling tubes are mounted on at least one surface of the body.

9. Heat shield according to claim 8, wherein the cooling tubes are one of formed from the fibre composite material and surrounded by the fibre composite material.

10. A heat shield having a thermally-conductive body, comprising:
at least one fiber composite layer, said layer formed from at least one of carbon fiber, glass fiber, glass fiber reinforced plastic and aramide; and
at least one layer containing metal elements, said at least one metal-containing layer being joined to at least one of the fiber composite layers to form the thermally-conductive body.

11. The heat shield according to claim 10, wherein the metal elements are at least one of rods, threads, strips and networks.

12. The heat shield of claim 11, wherein the body is formed from a plurality of alternating fiber composite and metal-containing layers.

13. The heat shield of claim 12, wherein the layers are symmetrically disposed relative to a center of a cross-section thickness direction of the heat shield body.

14. The heat shield of claim 13, wherein adjacent metal-containing layers are disposed in parallel to one another, and the metal elements of one metal-containing layer are disposed at approximately right angles to the metal elements of its adjacent metal-containing layer.

15. Heat shield according to claim 13, wherein the at least one outer surface of the body is composed of a metal.

16. Heat shield according to claim 15, wherein cooling tubes are mounted on at least one surface of the body.

17. Heat shield according to claim 16, wherein the cooling tubes are one of formed from the fibre composite material and surrounded by the fibre composite material.
